(19) United States
(12) Patent Application Publication
(10) Pub. No.: US 2023/0246672 A1
(43) Pub. Date: Aug. 3, 2023

(54) Upgradable Vehicle Electronics System, Upgrade Module and Associated Method

(71) Applicant: Aptiv Technologies Limited, St. Michael (BB)

(72) Inventors: Markus Neumann, Dublin (IE); Tim Welsch, Dublin (IE)

(21) Appl. No.: 18/162,488

(22) Filed: Jan. 31, 2023

(30) Foreign Application Priority Data
Feb. 2, 2022 (GB) 2201323.9
Jan. 25, 2023 (EP) 23153284.7

(51) Int. Cl. H04B 5/02; H02J 50/90; H02J 50/10; H04B 5/00

(52) U.S. Cl. CPC H04B 5/02; H02J 50/90; H02J 50/10; H04B 5/0031; H04B 5/0037

(57) ABSTRACT

Upgradable vehicle electronics system including a base unit being operable in combination with an upgrade module. A power transmitter is provided for delivering power to the upgrade module. A base wireless data transceiver is provided for wireless communication between the base unit and the upgrade module. A module locator is used to locate the upgrade module to align a power receiver on the upgrade module to the power transmitter to receive power therefrom and to align a module wireless data transceiver on the upgrade module with the base wireless data transceiver for wireless communication therebetween.

### INCORPORATION BY REFERENCE

This application claims priority to European Patent Application No. EP23153284.7, filed Jan. 25, 2023, and claims priority to United Kingdom Patent Application No. GB2201323.9, filed Feb. 2, 2022, the disclosures of which are incorporated by reference in their entireties.

### INTRODUCTION

The present disclosure relates to an upgradeable vehicle electronics system, and an upgrade module for use with the same, and a method for upgrading a vehicle electronics system. The present disclosure is particularly relevant to upgradable automotive infotainment systems and other such vehicle multimedia units that allow for plug and play modules to provide extended functionality.

### BACKGROUND

Vehicle multimedia units (MUs) have become an increasingly important part of modern vehicles for implementing infotainment and user experience (UX) applications for both drivers and passengers. However, the innovation cycles for such UX applications are significantly faster than a typical vehicle lifetime. As such, new UX applications will often require ever greater hardware capabilities and performance, such as processing power and memory, which were not available or considered necessary at the time the MU and vehicle was designed or manufactured. This means that a vehicle can become out of date in the market prematurely purely because its MU lacks the hardware capabilities to run the latest MU software.

Typically, it is not practical to upgrade a modern vehicle's MU entirely because of the complexity of its integration into the vehicle, both in terms of the MUs communications with other electronic control units (ECUs) in the vehicle and the hardwired physical connections used to establish those communications. Consideration has therefore been made to provide MUs with upgrade ports available to allow extension boards and units to be physically connected to the MU to upgrade its hardware specifications at a later date. As such, an MU installed in the vehicle at its production time may function as a base system for delivering the base UX applications available at the time of manufacture. In some instances, this base MU will incorporate a basic extension module connected to a connector port which can then be replaced by an upgraded module in the future. Alternatively, an MU may include an empty port that can receive a upgrade module which functions in combination with the existing processing systems.

To establish the communications between the module and the base unit, board-to-board connections, such as PCIe connectors, or harness connectors, such as USB connectors, have been proposed. This is because such connections allow for the very high data rates needed to implement UX applications. However, testing has shown that such connectors can become unreliable in vehicle applications, and most particularly in automotive applications. Specifically, such connection protocols use high-speed electrical signals transmitted through tiny electrical contacts between the module and base. However, the quality and reliability of these contacts can be compromised by humidity, dirt and electrostatic discharge contamination. Furthermore, vibrations of the vehicle, particularly in automotive applications, can cause mechanical stress on the connectors, resulting in loose connections over time. In addition, the fragility of the connectors means that they are susceptible to critical damage during handling. As such, upgrade operations cannot be reliably undertaken by end customers. This thereby means that a customer would need to take their vehicle to a specialist garage to perform the upgrade. The combination of these factors make any conventional upgrade systems expensive and impractical. As such, known vehicle MUs do not allow for straightforward hardware upgrades during their lifetime.

Accordingly, there remains a need to address the above shortcomings in conventional MUs and UX systems.

### SUMMARY

According to a first aspect, there is provided a vehicle electronics system including: a base unit being operable in combination with a module; a power transmitter for delivering power to the upgrade module; a base wireless data transceiver for wireless communication between the base unit and the module; and a module locator for locating the module to align a power receiver on the module to the power transmitter to receive power therefrom and to align a module wireless data transceiver on the module with the base wireless data transceiver for wireless communication therebetween.

In this way, an electronics system, such as a multimedia unit, may be upgraded within a vehicle without needing to replace the base unit. Accordingly, additional hardware components, such as Systems on a Chip (SoC), processors, and memory contained within an upgrade module, may be communicatively connected to operate in conjunction with the base unit. Moreover, this can be achieved by simply locating the module on the module locator, such as a receptacle, platform or docking location. Furthermore, as communications are established wirelessly, the datalink between the upgrade module and the base unit is not subject to the limitations of a physical electrical connection between the parts. Consequently, it is much more tolerant to mechanical displacement, and in turn locational displacement and vibrational movements. The wireless datalink is also more tolerant to the presence of contaminants and humidity. As a result, reliability of the datalink during operating conditions is much more robust and connection of the upgrade module does not necessitate specialist training. In automotive electronics systems, this may be especially advantageous because multimedia units can be upgraded to provide new functionality during the vehicle's lifespan, and such upgrades may be undertaken by end customers. This reduces costs and allows an up to date user experience to be continually provided.

In embodiments, the vehicle electronics system further includes the module.

In embodiments, the base unit includes a plurality of base electronic components for implementing base electronic functions and, when the module is located in the module locator, upgrade electronic components in the module are operable in combination with the base electronic components for implementing upgraded electronic functions. In this way, components within the module may operate in combination with existing components in the base unit, which already provided basic functionality, but together may provide additional or enhanced functionality. As such, a vehicle may be manufactured with a base unit, and upgrade modules may be added in time, depending on an end customers requirements.

In embodiments, the power transmitter is a wireless power transmitter. In this way, no physical electrical connections are required between the module and the base unit. Consequently, the parts may be functionally coupled without requiring precise physical connection between electrical terminals. At the same time, the module may be provided as an enclosed or sealed unit, allowing for improved integrity and reliability under operating conditions. The wireless power transmitter may, for example, utilise inductive coupling, resonance coupling, or capacitive coupling.

In embodiments, the wireless power transmitter includes a data transfer modulator for transferring data between the power receiver and the power transmitter. In this way, an additional data link can be established between the module and the base unit. Usefully, because data may be transmitted through the wireless power coupling, it may be used for transmitting initialisation data during boot up of the components in the module.

In embodiments, the module locator comprises a receptacle for securing the module in an aligned position for the power transmitter and the base wireless data transceiver when the module is received into the receptacle. In this way, the module may be seated into the receptacle which orientates it into an aligned position for establishing the power and data links. The receptacle may be provided as a slot or dock, or keying formations on a platform for orientating the module. In embodiments, a retainer may be provided for securing the module in the module locator. For example, a magnetic retainer or clip may be used. In embodiments, the module locator comprises a receptacle dimensioned for receiving the module such that the module is retained in an aligned position for the power transmitter and the base wireless data transceiver.

In embodiments, the module locator further includes a cooling surface for absorbing heat from the module. In this way, waste heat generated by the components within the module during operation may be transferred away from the module into the module locator. This helps to maintain operation of the components and provides for heat spreading to avoid hotspots. In embodiments, the cooling surface may include a heat sink, a heat pipe, a heat spreader, or coolant conducting channels. In embodiments, the cooling surface may be formed of a heat transfer material, such as aluminium.

In embodiments, the cooling surface is located for absorbing heat from a heat dissipation region of the module when the module is located in the module locator. In this way, the cooling surface may be positioned so that it mates with the heat dissipation region of the module to ensure a high heat transfer efficiency. In embodiments, the heat dissipation region may be formed of a heat transfer material, such as aluminium.

In embodiments, the base wireless data transceiver comprises a plurality of antennas for communication with a plurality of antennas of the module wireless data transceiver using a Multiple-Input Multiple-Output method. In this way, multiple antennas may be used in combination in a MIMO method to increase data transfer rates between the base unit and module. In embodiments, the antennas of the base wireless data transceiver may be spatially distributed around the module for controlling cross correlation.

In embodiments, the base and module wireless data transceivers communicate using one of a radio-frequency link, a wireless personal area network, a microwave link, an optical link, and a two digit GHz data link. In this way, a high-speed, low latency, wireless datalink may be established.

In embodiments, the vehicle electronics system further includes a module receiving part for housing the power transmitter, the base wireless data transceiver, and the module locator, and wherein the module receiving part is electrically connected to the base unit through a cable connector. In this way, the module receiving part may be located away from the base unit. For example, the module may be provided in a location separate to the base unit. For instance, it may be hidden away or alternatively provided in a prominent location to facilitate ease of access. In automotive applications, for instance, this may allow the base unit to be located in a central console to provide the driver with convenient access, without the module locator for the module occupying valuable dashboard real estate. In other embodiments, the receiving part may be incorporated into the base unit. For example, the base unit may include a slot for receiving an module.

According to a second aspect, there is provided an upgrade module for an upgradable vehicle electronics system comprising: a power receiver for receiving power from the system; and a module wireless data transceiver for wireless communication between the upgrade module and a base unit of the system, wherein the power receiver and the module wireless data transceiver are located on the module such that, when the upgrade module is located on a module locator in the system, the power receiver is aligned to a power transmitter of the system to receive power therefrom and the module wireless data transceiver is aligned to a base wireless data transceiver for wireless communication therebetween. In this way, a modular system may be provided for upgrading functionality in a vehicle electronics system. For example, new or extended UX functions may be provided to an existing MU through the addition of the upgrade module.

In embodiments, the module may be provided as a sealed unit. In this way, an enclosed, self-contained, upgrade module may be provided, whilst, at the same time, allowing for improved integrity and reliability under operating conditions.

In embodiments, the power receiver is a wireless power receiver. In embodiments, the power receiver includes a data transfer modulator and demodulator for transferring data between the power receiver and the power transmitter. In this way, an additional data link can be established between the upgrade module and the base unit. In such embodiments, the power transmitter may also include a data transfer modulator and demodulator for transferring data between the power receiver and the power transmitter.

In embodiments, the upgrade module further includes a heat dissipation region for conducting heat from components in the upgrade module to a cooling surface provided in the module locator when the upgrade module is located in the module locator. In this way, the upgrade module may include an integral heat dissipation mechanism for transferring heat away from components within the module.

In embodiments, the upgrade module further includes a rechargeable energy store for powering components within the module prior to the power receiver receiving power from the system.

According to a third aspect, there is provided a method of upgrading a vehicle electronics system including the steps of: providing an upgrade module having a power receiver and a module wireless data transceiver; providing a base unit, a power transmitter, a base wireless data transceiver, and a module locator for the upgrade module; and locating the upgrade module on the module locator to align its power receiver to the power transmitter for receiving power therefrom and to align its module wireless data transceiver to the base wireless data transceiver for wireless communication therebetween.

In embodiments, the method further comprises the steps of: transmitting power from the power transmitter to the power receiver for powering components in the upgrade module; modulating the power transmitted for transferring initialisation data between the power receiver and the power transmitter; processing the initialisation data using the powered components in the upgrade module; and activating the module wireless data transceiver based on the processed initialisation data to establish wireless communications with the base wireless data transceiver. In this way, the wireless power coupling may be used as an additional data link for transmitting initialisation data during boot up of the components in the upgrade module, which in turn may allow the parameters for the high-speed datalink to be established.

### BRIEF DESCRIPTION OF DRAWINGS

Illustrative embodiments will now be described with reference to the accompanying drawings in which:

FIG. 1 is a cross sectional schematic illustration of an upgradeable vehicle electronics system according to a first embodiment, with the upgrade module separated from the base unit;

FIG. 2 is a cross sectional schematic illustration of the upgradeable vehicle electronics system shown in FIG. 1 with the upgrade module inserted into the base unit;

FIG. 3 is a simplified block diagram of the upgradeable vehicle electronics system of the first embodiment;

FIG. 4 is a cross sectional schematic illustration of an upgradeable vehicle electronics system according to a second embodiment;

FIG. 5 is a cross sectional schematic illustration of an upgradeable vehicle electronics system according to a third embodiment;

FIG. 6 is a cross sectional schematic illustration of an upgradeable vehicle electronics system according to a fourth embodiment; and

FIG. 7 is an isometric schematic illustration of the antenna positions in an upgradeable vehicle electronics system according to a fifth embodiment.

### DETAILED DESCRIPTION

With reference to FIG. 1, an upgradeable vehicle electronics system 1 according to a first embodiment is shown. In this embodiment, the system 1 is an automotive Multimedia Unit (MU) for implementing infotainment and other user experience (UX) functions. The system 1 includes an upgrade module 2 and a base unit 10.

The upgrade module 2 is provided as a hermetically sealed cartridge which can be inserted into a slot 12 provided in the base unit 10. The module 2 houses a plurality of electronic components for implementing UX functionality through the base unit 10, as well as a wireless charge receiver coil 13, a heat sink 14 and a WLAN transceiver 3. The wireless charge receiver coil 13 is located in the interior of the module casing, at the bottom of the module. The WLAN transceiver 3 is located at an insertion end of the module 2.

The heat sink 14 is thermally connected to the components within the interior of the module 2, and provides a thermal pathway from those components to an upper region of the module casing. In other embodiments, an internal heat spreading element may be used to distribute heat efficiently over the whole module to maximise transfer of heat away from hot components over a larger surface area.

The base unit 10 is fixed into the dashboard 4 of the vehicle and includes the slot 12 for receiving the upgrade module 2, a wireless charge transmitter coil 11, a cooling plate 5, and a WLAN transceiver 8. The base unit 10 also includes base processing section 9 which houses a plurality of electronic components for implementing the base UX functions. It will be understood that the base unit 10 may incorporate or be connected to a display and speakers, as well as other devices, controls, and sensors within the vehicle to implement those UX functions.

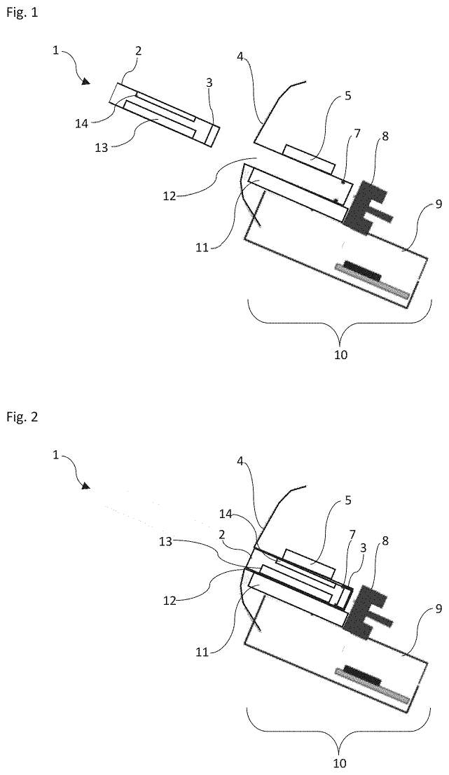

The slot 12 functions as a locator for the module 2 and incorporates a resilient retention formation 7 which is resiliently compressed when the module 2 is inserted into the slot 12, as shown in FIG. 2. This acts to retain the module 2 within the slot and also dampen any vibrational forces applied through movement of the vehicle.

The base unit's wireless charge transmitter coil 11, cooling plate 5, and WLAN transceiver 8 are positioned relative to the slot 11 such that when the module 2 is inserted, as shown in FIG. 2, these parts are aligned with their corresponding parts in the module 2. As such, the base unit's wireless charge transmitter coil 11 is located adjacent to the bottom surface of the slot 12, and the WLAN transceiver 8 is located adjacent to the terminal end of the slot 12. This minimises the distance between these parts to optimise their functional coupling and maximise performance.

In this connection, the WLAN transceivers 3 and 8 are operable to provide a high-speed, low-latency datalink between the components of the base unit 10 and the module 2. The datalink may include static control channels, low speed logical data channels and high speed (e.g. 0.5 Gbit/s˜10 GBps) logical data channels. In embodiments, the datalink may also be provided as an ASK modulated short distance radio link, with a carrier frequency in the two-digit GHz range. Although the WLAN protocol, as well as other wireless personal area network protocols, do not require precise alignment between the transceivers, the locating effect of the slot 12 allows higher speeds to be used, thereby minimising potential interference.

In the case of the wireless charging coils 11 and 13, these form an inductive coupling in the range of 50 to 500 kHz or resonance coupling in the frequency range of 3 to 30 MHz, primarily for transferring power from the base unit 10 to the module 2 for powering it during use. As such, both the module 2 and base unit 10 parts are equipped with coils that are operated close to resonance frequency and/or brought into a tight magnetic coupling. Typically, power transmission of operational power is achieved between 50 and 500 kHz or 3 to 30 MHz. In other embodiments, other wireless charging technologies may be used, such as capacitive wireless charging. At the same time, the power transfer coupling may also provide bidirectional communication between the wireless charging coil 11 in the base unit and the wireless charge receiver coil 13 in the upgrade module 2. For this, the charging coil arrangements each include a modulator/demodulator for modulating the power transfer signal to encode an additional, low speed, datalink. This is particularly useful for general control functionality, with the controller or processor in each of the module and base units being connected to the modulators/demodulators associated with the wireless power link coils 11,14.

In addition to the above, the cooling plate 5 also forms a region of the upper surface of the slot 12 for improving heat transfer away from the module 2 during use. As such, once the module 2 is inserted, the cooling plate 5 mates with the heat sink 14 for drawing heat therefrom. That is, waste heat from the module 2 is concentrated to the heatsink area and is, in turn, transferred to the cooling plate 5 for transport away to another part of the vehicle. In embodiments, the cooling plate 5 may include a fluid coolant transfer circuit to enhance cooling efficiency.

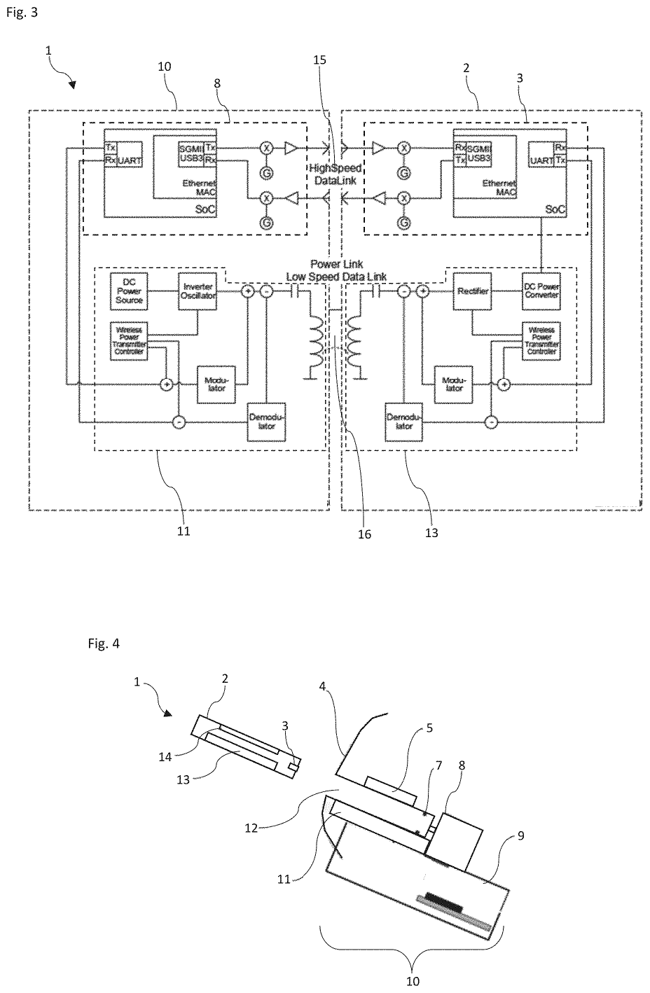

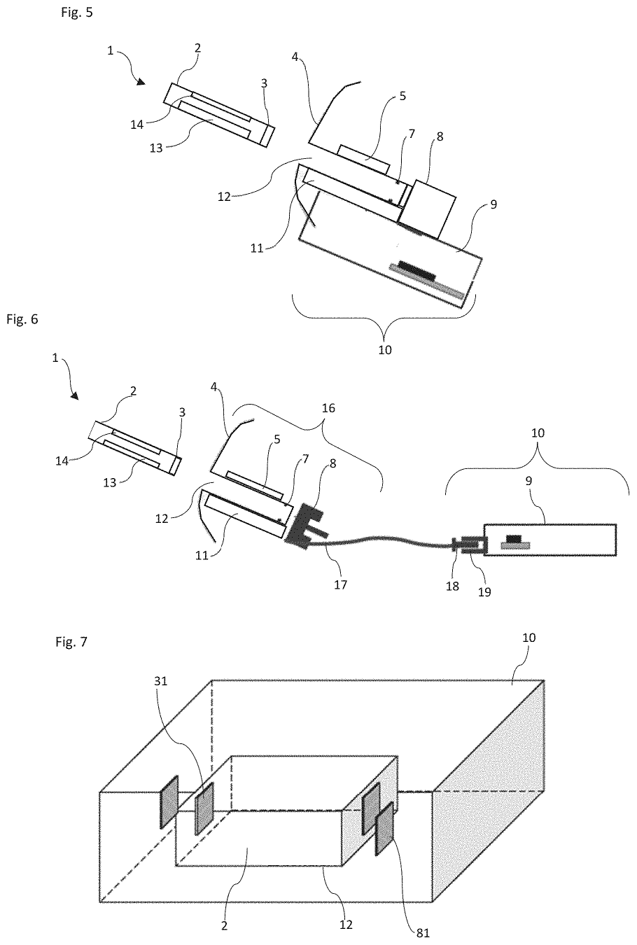

FIG. 3 shows a simplified circuit diagram of the upgradeable vehicle electronics system 1 shown in FIGS. 1 and 2. As shown, with the upgrade module 2 located in the slot 12, a high-speed data link 15 can be established between their respective WLAN transceivers 3 and 8, and a power link/low speed data link 16 can be established between their respective wireless charging coils 11 and 13.

In use, the module 2 is located in the slot 12. During the boot sequence of the base unit 10, a low to medium energy is applied via the wireless charge transmitter coil 11, which transferers power to the module 2 for booting the components therein. This then triggers a initialising communication process in which control data is transmitted between the module and base for allowing the base unit 10 to recognise the presence of the module 2 and communicatively pair the parts. For this, diagnosis data is exchanged between the parts for setting communication protocols, operational parameters and power requirements. The base processing section 9 then enables high energy charging through the power link 16 for powering the enhanced functionality within the module 2. This results in booting of the System on Chip component within the module 2, and establishes the high-speed data link 15. The operational status of the high-speed data link 15 and the modules' SoC component may be periodically updated via the power link/lower speed data link 16.

With the above arrangement, the electronics system 1 may be upgraded by making use of the additional hardware components in the upgrade module 2. That is, once the high-speed datalink 15 has been established, the base processing section 9 may be communicatively connected to operate in conjunction with the components in the upgrade module 2. Importantly, this is not subject to the limitations of a physical electrical connection between the parts, and hence is more robust. This thereby allows for a multimedia unit to be upgraded to provide new functionality during the vehicle's lifespan.

It will be understood that the high-speed datalink 15 may be implemented using other communication protocols, such as other Wireless Personal Area Network technologies, for instance WiFi. In other embodiments, an optical connection or a microwave-link, such as a 60 GHz communication channel, may be used.

In this respect, FIG. 4 shows a second embodiment which uses high-speed, bidirectional optical transceivers 3 and 8 to establish the high-speed datalink 15 between the module 2 and the base unit 10. In such an arrangement, the electrical signals are encoded into a modulated optical signal and are extracted back to an electrical signal on the receiver side. The remaining parts of the system 1 are the same as the first embodiment. Although in this second embodiment, more accurate alignment between the optical transceivers 3 and 8 is required compared to the WLAN transceivers in the first embodiment, it is nevertheless relatively tolerant to small movements between the parts. As such, a robust datalink may be maintained throughout operation of the module. FIG. 4 similarly shows a third embodiment which uses two uni-directional directional GHz data links transceivers 3 and 8 to establish the high-speed datalink 15 between the module 2 and the base unit 10. Again, the remaining parts of the system are the same as the first embodiment.

FIG. 6 shows a fifth embodiment which similarly uses WLAN transceivers to the first embodiment, but differs in that it has a module receiving part 16 that is provided separately to the base unit 10. That is, the module receiving part 16 houses the wireless power coil 11, the WLAN transceiver 11, the cooling plate 5, and the slot 12. The base processing section 9 is connected to the module receiving part 16 via a cable 17 which has a connector 18 that connects into a port 19 on the base processing part. This allows for greater flexibility in positioning, mounting, and cooling the upgrade module.

FIG. 7 shows a fifth embodiment which makes use of a multiple-input and multiple-output (MIMO) methodology in the WLAN Band. That is, the base unit 10 incorporates a plurality of datalink antennas 81. In this embodiment two base datalink antennas 81 are provided, spatially distanced on either side of the slot 12. At the same time, the upgrade module 2 is provided with a corresponding plurality of datalink antennas 31, which become aligned with the base datalink antennas 81 when the module 2 is located in the slot 12 to form two antenna pairs. In combination, these allows several Rx and/or Tx channels to be implemented on the high-speed datalink 15. Furthermore, the fixed and defined spatial distribution of the antennas allows maximum decoupling between the channels. In other embodiments, slotlines and couplers may be used as an alternative to or a realisation of the MiMo antennas, and it will be understood that implementations are not limited to WLAN frequency bands and two MiMo Channels.

It will be understood that the embodiments illustrated above show applications only for the purposes of illustration. In practice, embodiments may be applied to many different configurations, the detailed embodiments being straightforward for those skilled in the art to implement.

For example, it will be understood that, although in the above illustrative embodiments the power link is modulated to provide a low speed data link, a channel for transmitting diagnostic data may also be implemented using other communication methods, such as Near-field communication (NFC), Ultra-wideband (UWB), Bluetooth (BT-LE).

Furthermore, it will also be understood that, although in the above illustrative embodiments the power link is provided as a wireless power link, the power link may alternatively use electrical contacts. For example, terminals on the base unit may engage with two isolated contact surfaces provided on the module, thereby allowing the module to be hermetically sealed, whilst also providing relatively good location tolerance.

Finally, it will also be understood that the upgrade module may further include a small, re-chargeable, energy store, such as a capacitor or battery for providing a buffer to allow diagnostic data communication before the wireless power transfer is established. In this way, an earlier synchronisation between module and base unit may be established, thereby allowing the system to be available to provide end-user functionality earlier in time after the module has been located. This may also, for instance, allow for diagnostic operations in the event that the module is located improperly or not located on the module locator at all (e.g. if left in a user's bag). In such a scenario, the module may be detected as present in the vehicle cabin but not plugged in, and an alert may be triggered to remind the user to locate the module.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

1-15. (canceled)

16. A system comprising:
a base unit being operable in combination with a module;
a power transmitter for delivering power to the module;
a base wireless data transceiver for wireless communication between the base unit and the module; and
a module locator for locating the module to align a power receiver on the module to the power transmitter to receive power therefrom and to align a module wireless data transceiver on the module with the base wireless data transceiver for wireless communication therebetween.

17. The system according to claim 16, further comprising the module.

18. The system according to claim 16, wherein the module locator further comprises a cooling surface for absorbing heat from the module.

19. The system according to claim 16,
wherein the base unit comprises a plurality of base electronic components for implementing base electronic functions, and
wherein when the module is located in the module locator, upgrade electronic components in the module are operable in combination with the base electronic components for implementing upgraded electronic functions.

20. The system according to claim 16, wherein the power transmitter is a wireless power transmitter.

21. The system according to claim 20, wherein the wireless power transmitter comprises:
a data transfer modulator for transferring data between the power receiver and the power transmitter.

22. The system according to claim 16, wherein the module locator comprises:
a receptacle for securing the module in an aligned position for the power transmitter and the base wireless data transceiver when the module is received into the receptacle.

23. The system according to claim 16, wherein the base wireless data transceiver comprises:
a first plurality of antennas for communication with a second plurality of antennas of the module wireless data transceiver using a Multiple-Input Multiple-Output method.

24. The system according to claim 16, wherein the base wireless data transceiver and the module wireless data transceiver communicate using at least one of a radio frequency link, a wireless personal area network, a microwave link, an optical link, or a two digit GHz data link.

25. The system according to claim 16, further comprising:
a module receiving part for housing the power transmitter, the base wireless data transceiver, and the module locator.

26. The system according to claim 25, wherein the module receiving part is electrically connected to the base unit through a cable connector.

27. The system according to claim 16:
wherein the base unit comprises a plurality of base electronic components for implementing base electronic functions and, when the module is located in the module locator, upgrade electronic components in the module are operable in combination with the base electronic components for implementing upgraded electronic functions, and
wherein the power transmitter is a wireless power transmitter.

28. The system according to claim 27, wherein the base wireless data transceiver and the module wireless data transceiver communicate using at least one of a radio frequency link, a wireless personal area network, a microwave link, an optical link, or a two digit GHz data link.

29. The system according to claim 16,
wherein the base unit comprises a plurality of base electronic components for implementing base electronic functions,
wherein when the module is located in the module locator, upgrade electronic components in the module are operable in combination with the base electronic components for implementing upgraded electronic functions, and
wherein the base wireless data transceiver and the module wireless data transceiver communicate using at least one of a radio frequency link, a wireless personal area network, a microwave link, an optical link, or a two digit GHz data link.

30. A module for a vehicle electronics system comprising:
a power receiver for receiving power from the vehicle electronics system; and
a module wireless data transceiver for wireless communication between the module and a base unit of the vehicle electronics system,
wherein the power receiver and the module wireless data transceiver are located on the module such that, when the module is located on a module locator in the vehicle electronics system, the power receiver is aligned to a power transmitter of the vehicle electronics system to receive power therefrom and the module wireless data transceiver is aligned to a base wireless data transceiver for wireless communication therebetween.

31. The module according to claim 30, wherein the power receiver is a wireless power receiver, the wireless power receiver comprising a data transfer modulator for transferring data between the wireless power receiver and the power transmitter.

32. The module according to claim 30, further comprising a heat dissipation region for conducting heat from components in the module to a cooling surface provided in the module locator when the module is located in the module locator.

33. The module according to claim 30, further comprising a rechargeable energy store for powering components within the module prior to the power receiver receiving power from the vehicle electronics system.

34. A method of upgrading a vehicle electronics system comprising the steps of:
providing an upgrade module having a power receiver and a module wireless data transceiver;
providing a base unit, a power transmitter, a base wireless data transceiver, and a module locator for the upgrade module; and
locating the upgrade module on the module locator to align the power receiver to the power transmitter for receiving power therefrom and to align the module wireless data transceiver to the base wireless data transceiver for wireless communication therebetween.

35. The method according to claim 34, further comprising the steps of:
transmitting power from the power transmitter to the power receiver for powering components in the upgrade module;
modulating the power transmitted for transferring initialisation data between the power receiver and the power transmitter;
processing the initialisation data using the powered components in the upgrade module; and
activating the module wireless data transceiver based on the processed initialisation data to establish wireless communications with the base wireless data transceiver.
